(19) United States
(12) Patent Application Publication
(10) Pub. No.: US 2025/0101796 A1
(43) Pub. Date: Mar. 27, 2025

(54) SWING DOOR

(71) Applicant: UNIFLOW CO., LTD., Tokyo (JP)

(72) Inventors: Sayumi ISHIBASHI, Tokyo (JP); Tetsuji FUSE, Tokyo (JP); Toshiaki HIRATA, Tokyo (JP); Hiroshi TAMAYAMA, Tokyo (JP)

(21) Appl. No.: 18/723,160

(22) PCT Filed: May 10, 2023
(86) PCT No.: PCT/JP2023/017527

§ 371 Date: Jun. 21, 2024

(30) Foreign Application Priority Data
Jun. 17, 2022 (JP) 2022-097804

(51) Int. Cl. E06B 3/34; E06B 7/28

(52) U.S. Cl. CPC E06B 3/34; E06B 7/28

(57) ABSTRACT

By forming a swing door 1 including a door plate 11 rotatable in a front-rear direction with respect to a door frame via an upper hinge 12 pivotably and rotatably supporting an upper corner on a door end side and a lower hinge 13 pivotably and rotatably supporting a lower corner on the door end side, and a display monitor 14 incorporated in the door plate 11, the swing door 1 that can be said to be a place facing a flow of passersby, a place used by a relatively large number of people, or a place that is highly likely to be unconsciously viewed by passersby but has not been utilized as an installation place of digital signage so far can be newly utilized as digital signage.

### DESCRIPTION

### Technical Field

The present invention relates to a swing door, and is particularly suitable for use in a swing door including a door plate swingable in a front-rear direction with respect to a door frame.

### Background Art

Conventionally, digital signage has been widely used in which a display device such as a display or a projector is installed in various facilities such as a station, an airport, a store, an office, a university, and a hotel to transmit information. Digital signage has attracted much attention in recent years because this can easily and timely transmit more information than conventional posters and signboards.

The digital signage is preferably installed in a place where people gather or a place where a passerby is likely to unconsciously view a monitor. For example, examples of an effective installation place include the vicinity of an escalator or an entrance in a facility, a hall used for meeting and the like. A digital signage in which a monitor is incorporated in a landing door main body of an elevator, and a video, an advertisement, abnormal situation information and the like in a car are displayed on the monitor is also known (refer to, for example, Patent Literature 1).

### Patent Literature 1: JP 2015-13749 A

### SUMMARY OF INVENTION

### Technical Problem

An object of the present invention is to utilize digital signage in a new effective installation place.

### Solution to Problem

In order to solve the above-described problem, in the present invention, formed is a swing door including a door plate rotatable in a front-rear direction with respect to a door frame via an upper hinge that rotatably and pivotally supports an upper corner on a door end side, and a lower hinge that rotatably and pivotally supports a lower corner on the door end side, and a display monitor incorporated in the door plate.

### Advantageous Effects of Invention

According to the present invention configured as described above, a swing door in which a display monitor is incorporated in a door plate rotatable in a front-rear direction with respect to a door frame can be used as digital signage. Swing doors are widely used at entrances and exits of many facilities including public facilities, restaurants, factories, distribution warehouse and the like, in addition to various commercial facilities including department stores, shopping malls, supermarkets, home centers and the like. A place where the swing door is installed can be said to be a place facing a flow of passersby, a place used by a relatively large number of people, or a place that is highly likely to be unconsciously viewed by passersby, but this has not been utilized as an installation place of digital signage. According to the present invention, it is possible to utilize the digital signage in a novel and effective installation place, which is the swing door.

### BRIEF DESCRIPTION OF DRAWINGS

FIG. 1 is a view illustrating an overall configuration example of a swing door according to this embodiment.

FIG. 2 is an exploded perspective view illustrating a configuration example regarding incorporation of a display monitor in a door plate according to this embodiment.

FIG. 3 is a partially enlarged view illustrating the configuration example regarding incorporation of the display monitor in the door plate according to this embodiment.

FIG. 4 is a view illustrating a configuration example of a wiring passage on the door plate according to this embodiment.

FIG. 5 is a view illustrating a configuration example of a lower hinge according to this embodiment.

FIG. 6 is a view illustrating a configuration example of an upper hinge according to this embodiment.

FIG. 7 is a view illustrating an application example of the swing door according to this embodiment.

### DESCRIPTION OF EMBODIMENTS

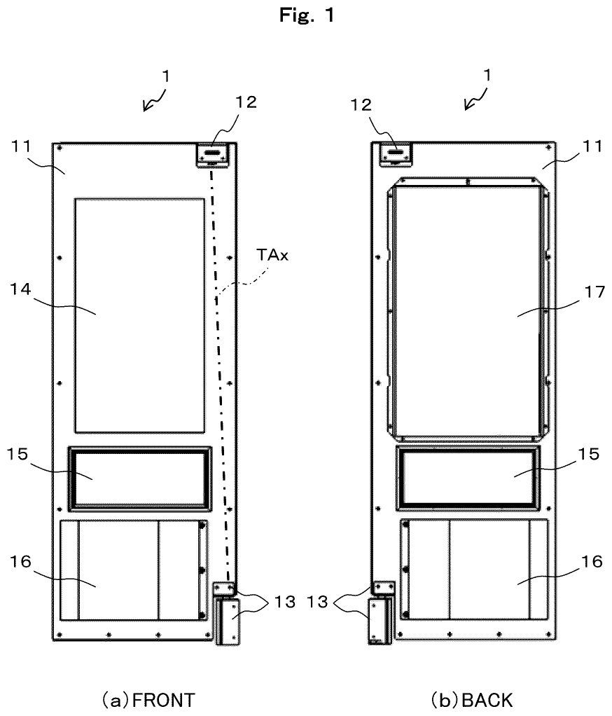

Hereinafter, an embodiment of the present invention will be described with reference to the drawings. FIG. 1 is a view illustrating an overall configuration example of a swing door 1 according to this embodiment, in which (a) is a front view and (b) is a back view.

As illustrated in FIG. 1, the swing door 1 of this embodiment includes a door plate 11 that is rotatable (swingable) in a front-rear direction (a direction in which a person passes through) with respect to a door frame not illustrated. The door plate 11 is rotatably attached to the door frame via an upper hinge 12 pivotably and rotatably supporting an upper corner on a door end side of the door plate 11 and a lower hinge 13 pivotably and rotatably supporting a lower corner on the door end side of the door plate 11. In the following description, the door end side refers to an edge side on which the door plate 11 is rotatably supported, and a door tip side refers to a free edge side on which the door plate 11 opens and closes.

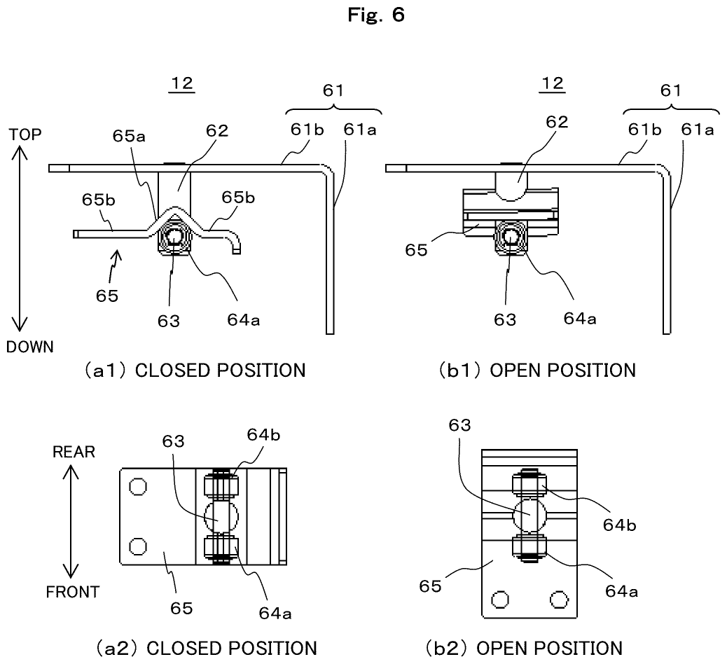

The upper hinge 12 and the lower hinge 13 are not aligned in position on a vertical axis and are installed in displaced positions. As a result, the door plate 11 is configured to rotate about an inclination axis TAx connecting the position of the upper hinge 12 and the position of the lower hinge 13. With such configuration, the door plate 11 is pushed by a passerby and gradually rises to open, and the center of gravity thereof is located higher when this is opened than when this is closed. Thereafter, when the passerby moves away from the door plate 11, the door plate 11 automatically returns to a closed position by its own weight (a specific configuration regarding this will be described later with reference to FIG. 6).

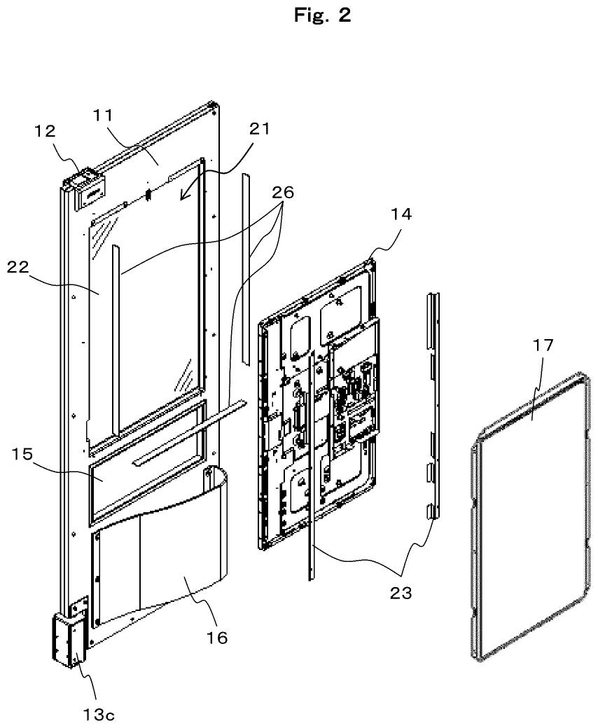

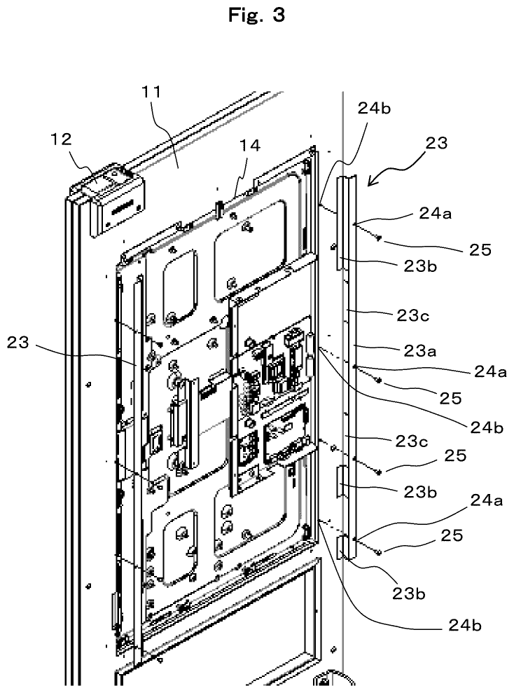

The swing door 1 of this embodiment includes a display monitor 14 incorporated in the door plate 11. As illustrated in FIG. 1, the display monitor 14 is incorporated in a position closer to an upper side than a central position in a top-to-down direction of the door plate 11. The display monitor 14 is incorporated in the door plate 11 in such a manner that a display surface thereof faces a front side illustrated in FIG. 1(a). Then, as illustrated in FIG. 1(b), a back surface of the display monitor 14 incorporated in the door plate 11 is covered with a back cover 17. Note that, a configuration regarding incorporation of the display monitor 14 will be described later in detail with reference to FIGS. 2 and 3.

The display monitor 14 displays various types of information including contents for guiding products and services, contents for guiding various events, contents for guiding discount, sale, limited period sale and the like, contents regarding fashion and topic, contents for guiding an evacuation method at the time of disaster and the like. Data for displaying these pieces of information is provided by communication from outside. As a result, the swing door 1 in which the display monitor 14 is incorporated can be used as digital signage.

A window 15 is provided below the display monitor 14, and a spring bumper 16 is provided below the window 15. The spring bumper 16 is provided on both the front side and a back side of the door plate 11. The window 15 is formed by, for example, incorporating an acrylic plate having translucency in an opening formed on the door plate 11. The spring bumper 16 is formed by, for example, pressing a flat plate of a hard resin material against a mold by a vacuum molding method or the like, and is molded so as to have a curved portion or a bent portion in a portion deviated to the door tip side.

FIGS. 2 and 3 are views illustrating a configuration example regarding incorporation of the display monitor 14 in the door plate 11. FIG. 2 is an exploded perspective view of the swing door 1 as seen obliquely from the back side, and FIG. 3 is a partially enlarged view of a state in which the display monitor 14 is accommodated in a housing space 21.

As illustrated in FIG. 2, display monitor 14 is a planar monitor having a predetermined thickness. In the display monitor 14 used in this embodiment, an electronic circuit module is not housed in a casing, and the electronic circuit module can be seen from outside. Therefore, the display surface on the front side is formed flat, whereas the back side thereof is not formed flat. In this embodiment, the planar monitor means the monitor formed into a substantially planar shape as a whole, whereas the back side is not flat, and the predetermined thickness of the planar monitor refers to a thickness from the display surface to a most protruding portion of the back surface. Note that, the planar monitor in which the electronic circuit module is housed in a rectangular casing may be used.

As illustrated in FIG. 2, the door plate 11 includes the housing space 21 having a predetermined size slightly larger than a planar size of the display monitor 14. The housing space 21 includes an acrylic plate 22 having translucency on a front side end face of the opening having a predetermined size formed on the door plate 11. As a result, the housing space 21 having a depth equivalent to the thickness of the door plate 11 is formed. The depth of the housing space 21 is equivalent to the thickness of the display monitor 14, but it is not essential that they are completely the same.

For example, the depth of the housing space 21 may be a value larger than the thickness of the display monitor 14. Alternatively, if a difference between the depth of the housing space 21 and the thickness of the display monitor 14 is a value equal to or smaller than a thickness of the back cover 17, the thickness of the display monitor 14 may be a value larger than the depth of the housing space 21. The back cover 17 has a bottomed rectangular dish shape with a low height, and is formed to be able to house a part of the display monitor 14 protruding outward from the housing space 21.

The swing door 1 of this embodiment includes a pressing fixture 23 fixed to the door plate 11 in a state of pressing a part of the back surface on a side opposite to the display surface of the display monitor 14 housed in the housing space 21. As illustrated in the partially enlarged view of FIG. 3, the pressing fixture 23 is formed by bending a metal plate, and includes a fixing portion 23a, which is a portion that abuts the door plate 11 to be fixed to the door plate 11, a pressing portion 23b, which is a portion that abuts or comes closer to the back surface of the display monitor 14 to press the display monitor 14, and a support portion 23c, which is a portion that abuts a side surface of the housing space 21 to perform positioning.

The fixing portion 23a is a metal piece having substantially the same length as that of a long side of the housing space 21, and is provided with screw holes 24a dispersed at a plurality of locations. The door plate 11 is also provided with screw holes 24b in positions opposed to the screw holes 24a of the fixing portion 23a. As a result, the pressing fixture 23 is fixed to the door plate 11 with screws 25 in a state in which the fixing portion 23a abuts the door plate 11.

The pressing portion 23b is a hook-shaped metal piece formed so as to be bent from the fixing portion 23a, and abuts or comes closer to a recessed portion on the back surface of the display monitor 14. In the example in FIG. 3, three pressing portions 23b having different sizes are provided. These pressing portions 23b are formed in accordance with a position and a size of the recessed portion on the back surface of the display monitor 14. Note that, the position in which the pressing portion 23b is provided is preferably a position close to an end of the pressing fixture 23.

The support portion 23c is a flat plate-shaped metal piece formed so as to be bent from the fixing portion 23a, and has a role of facilitating positioning when the pressing fixture 23 is fixed to the door plate 11 by abutting the side surface of the housing space 21. Note that, since the positioning can also be performed by the pressing portion 23b, it is not essential to provide the support portion 23c.

As illustrated in FIG. 2, cushioning materials 26 are arranged in a gap between side surfaces of the display monitor 14 housed in the housing space 21 and the side surfaces of the housing space 21. In this embodiment, the cushioning materials 26 are arranged in the gap between the side surfaces in three directions except for an upper side surface out of the side surfaces in upper, lower, right, and left four directions included in the housing space 21 and the side surfaces in three directions of the display monitor 14 housed in the housing space 21. The cushioning material 26 is arranged on the lower side surface out of the side surfaces in the four directions in consideration of gravity acting on the display monitor 14. The cushioning materials 26 are arranged on the right and left side surfaces in consideration of a centrifugal force acting when the swing door 1 rotates.

As described above, since the swing door 1 of this embodiment is configured in such a manner that the door plate 11 rotates about the inclination axis TAx, the door plate 11 twists at the time of rotation. The display monitor 14 is incorporated in the door plate 11 having such a property. In this embodiment, in order to reduce a physical load applied to the display monitor 14 by the twist of the door plate 11, the housing space 21 is formed into a predetermined size slightly larger than a planar size of the display monitor 14, and the cushioning materials 26 are arranged in the gap between the display monitor 14 housed therein and the housing space 21. The display monitor 14 is not completely fixed to the housing space 21 with screws or the like, but is merely pressed by the pressing fixture 23. With this configuration, even if the door plate 11 is twisted when the swing door 1 rotates, a distortion force that the display monitor 14 receives from the door plate 11 can be minimized.

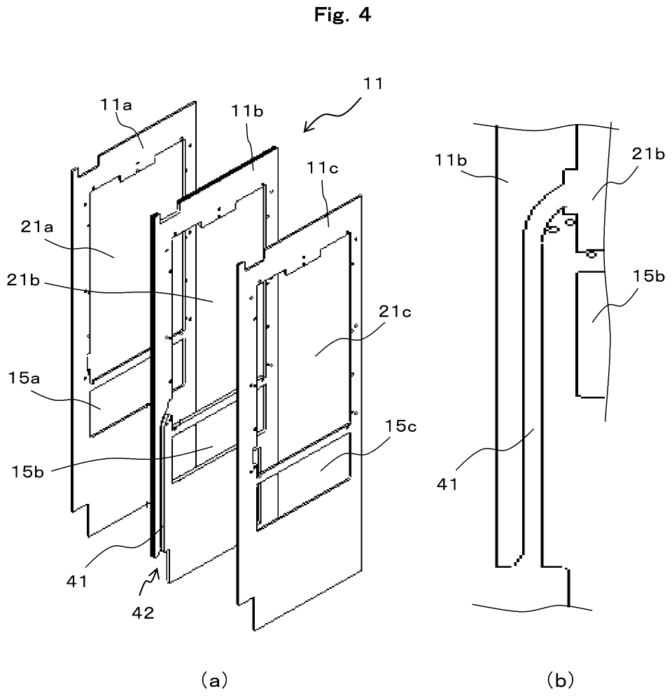

Next, a configuration regarding wiring to the display monitor 14 will be described. FIG. 4 is a view illustrating a configuration example of a wiring passage in the door plate 11. FIG. 4(a) is an exploded perspective view of the door plate 11 as seen obliquely from the back side, and FIG. 4(b) is a partially enlarged view of a core material 11b as seen from the back side.

As illustrated in FIG. 4(a), the door plate 11 of this embodiment has a layered structure in which three surface materials 11a to 11c are arranged to be opposed to one another to be joined. Planar shapes of the three surface materials 11a to 11c are the same, but the thicknesses thereof are different. For example, while a front surface material 11a and a back surface material 11c have the same thickness, the core material 11b in the center is formed to be thicker than the front and back surface materials 11a and 11c. For example, the thickness of the front and back surface materials 11a and 11c is 9 mm, and the thickness of the core material 11b is 18 mm.

The three surface materials 11a to 11c have openings 21a to 21c having the same planar shape, respectively, and the housing space 21 is formed by the layered structure of the openings 21a to 21c. The three surface materials 11a to 11c have openings 15a to 15c having the same planar shape below the openings 21a to 21c, respectively, and the window 15 is formed by the layered structure of the openings 15a to 15c.

Note that, any material may be used for the three surface materials 11a to 11c, and any method of joining them may be used. For example, all of the surface materials 11a to 11c may be made of wooden plates, and they may be bonded with an adhesive. In place of or in addition to the adhesive, they may be fixed using a screw. The core material 11b may be made of a resin, a paper core, foamed urethane or the like. As the front and back surface materials 11a and 11c, steel plates may be used in place of the wooden plates.

Among the three surface materials 11a to 11c, the core material 11b arranged at the center includes a slit 41 for passing the wiring from a part of the side surface to the housing space 21 (specifically, to the opening 21b). The slit 41 is a through groove penetrating from the front surface to the back surface of the core material 11b. In contrast, no slit is formed on the front and back surface materials 11a and 11c in a position opposed to the slit 41 of the core material 11b. As a result, when the three surface materials 11a to 11c are bonded to each other, the wiring passage having the same thickness as that of the core material 11b is formed by the slit 41.

As described above, one end of the slit 41 is the opening 21b, and the other end is a part of the side surface of the core material 11b. In this embodiment, the part of the side surface is a cutout 42 formed on the door end side on the lower side surface. The cutout 42 is a portion to which the lower hinge 13 is attached. That is, the slit 41 is formed from an end of the portion in which the lower hinge 13 is arranged to the housing space 21. In this embodiment, the wiring passage is further formed in the lower hinge 13. As a result, the lower hinge 13 and the slit 41 of the core material 11b form the wiring passage.

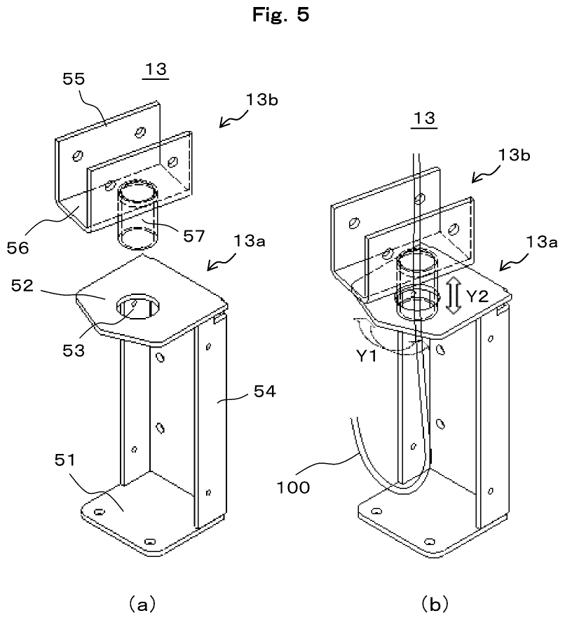

FIG. 5 is a view illustrating a configuration example of the lower hinge 13. FIG. 5(a) illustrates an exploded view of two members forming the lower hinge 13, and FIG. 5(b) illustrates a state in which the wiring is passed through the lower hinge 13. As illustrated in FIG. 5, the lower hinge 13 includes a door frame side hinge member 13a attached to the door frame not illustrated and a door plate side hinge member 13b attached to the door plate 11. The lower hinge 13 further includes a hinge cover 13c (refer to FIG. 2) that covers the door frame side hinge member 13a, but this is not illustrated in FIG. 5.

The door frame side hinge member 13a includes a base surface 51 fixed to the door frame and a sliding surface 52 provided in a position above the base surface 51 with a space therebetween, and the sliding surface 52 is provided with a through hole 53. The base surface 51 and the sliding surface 52 are coupled by a coupling portion 54 erected in a vertical direction from the base surface 51, and the coupling portion 54 is also fixed to the door frame. The coupling portion 54 is formed into a U-shaped in cross section in order to provide sufficient strength to stably support the door plate 11 in which the display monitor 14 is incorporated.

The door plate side hinge member 13b includes an attachment portion 55 having a U-shaped cross section to be attached to the door plate 11, and a cylindrical rotational shaft 57 protruding downward from a proximal end face 56 of the attachment portion 55. The rotational shaft 57 is inserted into the through hole 53 of the door frame side hinge member 13a. As a result, the door plate side hinge member 13b is configured to rotate in a direction indicated by arrow Y1 in FIG. 5(b) with respect to the door frame side hinge member 13a while sliding the proximal end face 56 on the sliding surface 52 of the door frame side hinge member 13a.

The rotational shaft 57 is hollow, and an end on the proximal end face 56 side of the rotational shaft 57 is located in the vicinity of an end of the slit 41 of the door plate 11 (core material 11b). As a result, as illustrated in FIG. 5(b), a wiring cord 100 can pass through the slit 41 from the door frame side hinge member 13a via a hollow portion of the rotational shaft 57, and the wiring cord 100 can be led out to the display monitor 14 housed in the housing space 21 via the slit 41.

In this manner, in this embodiment, the wiring to the display monitor 14 is performed via the wiring passage including an internal space provided in the vicinity of the end on the door end side of the door plate 11. Therefore, it is possible to draw the wiring necessary for power supply, communication and the like from the outside to the display monitor 14 of the housing space 21 in a mode in which the wiring is not detached or damaged by an influence of the rotation of the door plate 11.

FIG. 6 is a view illustrating a configuration example of the upper hinge 12. The upper hinge 12 of this embodiment is a hinge having a function of hanging the upper corner on the door end side of the door plate 11 so as to be rotatable with respect to the door frame and allowing the door plate 11 to automatically return from an open position to a closed position. FIG. 6 schematically illustrates an extracted configuration regarding this auto return function. FIGS. 6(a1) and 6(a2) illustrate a state in which the door plate 11 is in the closed position, in which FIG. 6(a1) is a front view, and FIG. 6(a2) is a top view. FIGS. 6(b1) and 6(b2) illustrate a state in which the door plate 11 is in the open position, in which FIG. 6(b1) is a front view, and FIG. 6(b2) is a top view. FIGS. 6(a2) and 6(b2) illustrate a configuration excluding a fixing member 61.

As illustrated in FIG. 6, the upper hinge 12 includes a fixing member 61 made of a sheet metal formed into a substantially L shape. The fixing member 61 includes a vertical portion 61a that extends in a top-to-down direction and is screwed to an inner surface of the door frame not illustrated, and a horizontal portion 61b that extends in a right-to-left direction and is screwed to a ceiling surface of the door frame. On a lower surface of the horizontal portion 61b, a longitudinal shaft 62 formed of a round bar is provided so as to face downward.

In the vicinity of a lower end of the longitudinal shaft 62, a lateral shaft 63 passes in the front-rear direction, and a pair of rollers 64a and 64b are rotatably supported on both ends of the lateral shaft 63. A cam plate 65 is rotatably passed through the longitudinal shaft 62. The cam plate 65 is a member placed on the pair of rollers 64a and 64b, and includes a V groove 65a recessed upward and flat portions 65b extending in a lateral direction on both right and left sides thereof as illustrated in FIG. 6(a1). The cam plate 65 is fixed to the door plate 11 via a coupling member not illustrated. As a result, the door plate 11 and the cam plate 65 rotate integrally.

When the door plate 11 is in the closed position, as illustrated in FIGS. 6(a1) and 6(a2), the pair of rollers 64a and 64b are fitted into the V groove 65a. At that time, a force corresponding to an own weight of the door plate 11 (to be precise, also including own weights of the coupling member, the cam plate 65 and the like) acts downward on the pair of rollers 64a and 64b.

In contrast, in a case where the door plate 11 is pushed by hand to be opened in the front-rear direction, the cam plate 65 rotates while getting on the rollers 64aand 64b according to an inclination of the V groove 65a. Then, as illustrated in FIGS. 6(b1) and 6(b2), in a state in which the pair of rollers 64a and 64b completely escape from the V groove 65a, the flat portion 65b of the lower surface of the cam plate 65 presses against the upper surfaces of the rollers 64a and 64b.

As described above, the door plate 11 rotates about the inclination axis TAx while gradually raising the center of gravity. That is, this gradually approaches from the state illustrated in FIGS. 6(a1) and 6(a2) to the state illustrated in FIGS. 6(b1) and 6(b2). Thereafter, when the hand is released from the door plate 11 after the door plate 11 is opened to an optional position, the door plate 11 automatically returns to the closed position by its own weight. That is, this gradually returns to the state illustrated in FIGS. 6(a1) and 6(a2). In this manner, in this embodiment, the upper hinge 12 has a configuration with the auto return function. Therefore, as illustrated in FIG. 5(b), the door plate side hinge member 13b moves up and down in the direction indicated by arrow Y2 when the door plate 11 rotates.

In contrast, by holding the wiring cord 100 in a loosened state in the space formed between the base surface 51 and the sliding surface 52 of the door frame side hinge member 13a, it is possible to avoid an influence on the wiring cord 100 due to vertical movement of the door plate side hinge member 13b when the door plate 11 rotates. As described above in detail, in this embodiment, the housing space 21 is provided in the door plate 11 rotatable in the front-rear direction, and the display monitor 14 is incorporated in the housing space 21 to form the swing door 1.

According to this embodiment configured as described above, the swing door 1 in which the display monitor 4 is incorporated in the door plate 11 can be used as digital signage. A place where the swing door 1 of this embodiment is installed can be said to be a place facing a flow of passersby, a place used by a relatively large number of people, or a place that is highly likely to be unconsciously viewed by passersby, but this has not been utilized as an installation place of digital signage. According to this embodiment, it is possible to utilize the digital signage in a novel and effective installation place, which is the swing door 1.

Especially, in this embodiment, in order to incorporate the display monitor 14 in the door plate 11 swinging in the front-rear direction, the display monitor 14 is not completely fixed to the housing space 21 with screw or the like, but is merely pressed by the pressing fixture 23, and the cushioning materials 26 are arranged in the gap between the display monitor 14 and the housing space 21. With this configuration, the physical load that the display monitor 14 receives from the door plate 11 when the door plate 11 rotates can be minimized.

In this embodiment, the slit 41 is provided in the central core material 11b out of the three layers of surface materials 11a to 11c forming the door plate 11, and a specific configuration is employed in the lower hinge 13, so that the wiring passage is formed in the vicinity of the end on the door end side of the door plate 11. As a result, it is possible to draw the wiring necessary for power supply, communication and the like from the outside to the display monitor 14 of the housing space 21 in a mode in which the wiring is not detached or damaged by the influence of the rotation of the door plate 11.

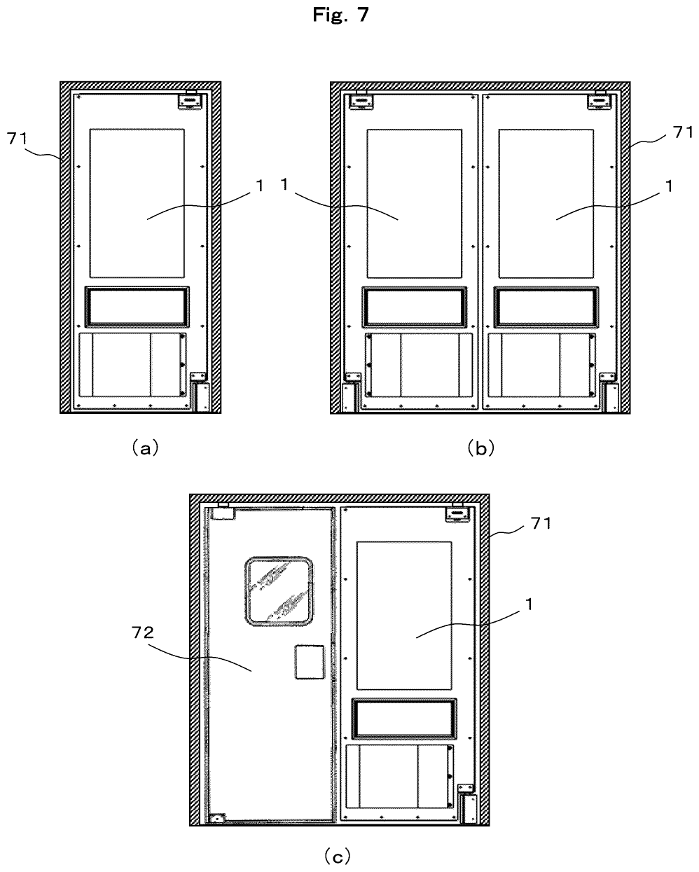

One swing door 1 of this embodiment configured as described above may be attached to the door frame 71 as illustrated in FIG. 7(a), or two swing doors 1 may be attached to the door frame 71 as illustrated in FIG. 7(b). As illustrated in FIG. 7(c), the swing door 1 of this embodiment and a normal swing door 72 without a display monitor can be attached to the door frame 71.

Note that, in the embodiment described above, the configuration in which the door plate 11 includes the window 15 and the spring bumper 16 in addition to the display monitor 14 has been described, but it is not essential to include the window 15 and the spring bumper 16. For example, it is possible that either the window 15 or the spring bumper 16 is provided, or none of the window 15 and the spring bumper 16 is provided.

In this embodiment, the example has been described in which the door plate 11 is configured to rotate about the inclination axis TAx by installing the upper hinge 12 and the lower hinge 13 in positions shifted from the vertical axis, and the upper hinge 12 is formed of a hinge having the auto return function, but the present invention is not limited thereto. For example, the upper and lower hinges may be installed in aligned positions on the vertical axis, and the display monitor 14 may be incorporated in the swing door in which the upper hinge is formed of a normal hinge without the auto return function. In this case, by forming either the upper hinge or the lower hinge as illustrated in FIG. 5, the slit 41 may be formed in the core material 11b from an end of a portion where either the upper hinge or the lower hinge is arranged to the housing space 21.

In the embodiment described above, the example in which the display monitor 14 is incorporated in the door plate 11 has been described, but a speaker may be incorporated in addition to this.

The present invention also includes embodiments described in the following supplementary notes.

### [Appendix 1]

A door plate for a swing door, the door plate attached to a door frame so as to be rotatably in a front-rear direction by an upper corner pivotably and rotatably supported by an upper hinge and a lower corner pivotably and rotatably supported by a lower hinge, the door plate including:

a housing space for storing a planar monitor in a position spaced apart from a side surface inward; and

a wiring passage for passing wiring from a part of the side surface to the housing space.

### [Appendix 2]

The door plate for a swing door according to appendix 1, wherein

the door plate has a layered structure obtained by arranging three surface materials so as to be opposed to one another, a core material arranged at the center out of the three surface materials includes a slit for passing the wiring from a part of the side surface to the housing space, and the slit forms the wiring passage.

### [Appendix 3]

The door plate for a swing door according to appendix 2, wherein the slit is formed from an end of a portion in which the upper hinge or the lower hinge is arranged to the housing space.

### [Appendix 4]

The door plate for a swing door swing door according to appendix 2, wherein

the upper hinge is a hinge that rotatably hangs the upper corner of the door plate with respect to the door frame and has a function of automatically returning the door plate from an open position to a closed position, and

the slit is formed from an end of a portion in which the lower hinge is arranged to the housing space.

### [Appendix 5]

A door lower hinge that pivotably and rotatably supports a lower corner of the door plate in such a manner that the door plate is rotatable in a front-rear direction with respect to a door frame, the door lower hinge including:

a door frame side hinge member including a base surface fixed to the door frame, and a sliding surface provided in a position above the base surface with a space between the base surface and the sliding surface; and

a door plate side hinge member including an attachment portion attached to the door plate, and a hollow rotational shaft protruding downward from a proximal end surface of the attachment portion, the rotational shaft inserted into the through hole, the door plate side hinge member rotating with respect to the frame side hinge member while sliding the proximal end surface on the sliding surface.

Each of the above embodiments is merely an example of implementation in implementing the present invention, and the technical scope of the present invention should not be interpreted in a limited manner. That is, the present invention can be implemented in various forms without departing from the gist or main features thereof.

### REFERENCE SIGNS LIST

1 Swing door
11 Door plate
12 Upper hinge
13 Lower hinge
13a Door frame side hinge member
13b Door plate side hinge member
14 Display monitor
21 Housing space
23 Pressing fixture
26 Cushioning material

### 41 Slit

51 Base surface
52 Sliding surface
53 Through hole
55 Attachment portion
56 Proximal end surface
57 Rotational shaft

1. A swing door comprising:
a door plate rotatable in a front-rear direction with respect to a door frame;
an upper hinge that rotatably and pivotally supports an upper corner on a door end side of the door plate;
a lower hinge that rotatably and pivotally supports a lower corner on the door end side of the door plate; and
a display monitor incorporated in the door plate.

2. The swing door according to claim 1, wherein
the display monitor is a planar monitor having a predetermined thickness,
the door plate includes a housing space of a predetermined size larger than a planar size of the display monitor, and
the swing door comprises a pressing fixture fixed to the door plate in a state of pressing a part of a back surface on a side opposite to a display surface of the display monitor housed in the housing space.

3. The swing door according to claim 2, wherein a cushioning material is arranged in a gap between a side surface of the display monitor housed in the housing space and the housing space.

4. The swing door according to claim 3, wherein cushioning materials are arranged in the gap between side surfaces in three directions except for an upper side surface out of side surfaces in upper, lower, right, and left four directions included in the housing space and the display monitor housed in the housing space.

5. The swing door according to claim 1, wherein
the display monitor is a planar monitor having a predetermined thickness,
the door plate has a layered structure obtained by arranging three surface materials so as to be opposed to one another to be joined and includes a housing space of a predetermined size larger than a planar size of the display monitor, and
a core material arranged at the center out of the three surface materials includes a slit for passing wiring from a part of the side surface to the housing space.

6. The swing door according to claim 5, wherein
the slit is formed from an end of a portion in which the upper hinge or the lower hinge is arranged to the housing space.

7. The swing door according to claim 5, wherein
the upper hinge is a hinge that rotatably hangs the upper corner of the door plate with respect to the door frame and has a function of automatically returning the door plate from an open position to a closed position, and
the slit is formed from an end of a portion in which the lower hinge is arranged to the housing space.

8. The swing door according to claim 7, wherein
the lower hinge includes:
a door frame side hinge member including a base surface fixed to the door frame, and a sliding surface provided in a position above the base surface with a space between the base surface and the sliding surface, the sliding surface provided with a through hole, and
a door plate side hinge member including an attachment portion attached to the door plate, and a rotational shaft protruding downward from a proximal end surface of the attachment portion, the rotational shaft inserted into the through hole, the door plate side hinge member rotating with respect to the door frame side hinge member while sliding the proximal end surface on the sliding surface, and
the rotational shaft is hollow, and an end of the rotational shaft is located in the vicinity of an end of the slit.

9. The swing door according to claim 5, comprising
a pressing fixture fixed to the door plate in a state of pressing a part of a back surface on a side opposite to a display surface of the display monitor housed in the housing space.

10. The swing door according to claim 6, comprising
a pressing fixture fixed to the door plate in a state of pressing a part of a back surface on a side opposite to a display surface of the display monitor housed in the housing space.

11. The swing door according to claim 7, comprising
a pressing fixture fixed to the door plate in a state of pressing a part of a back surface on a side opposite to a display surface of the display monitor housed in the housing space.

12. The swing door according to claim 8, comprising
a pressing fixture fixed to the door plate in a state of pressing a part of a back surface on a side opposite to a display surface of the display monitor housed in the housing space.
